(19) United States
(12) Patent Application Publication
(10) Pub. No.: US 2026/0129455 A1
(43) Pub. Date: May 7, 2026

(54) MULTI-SERVICE SECURITY SLICE MANAGEMENT FOR CELLULAR NETWORKS

(71) Applicant: DISH Wireless L.L.C., Englewood, CO (US)

(72) Inventors: Matthew Kniess, Lakewood, CO (US); Dale Drew, Arvada, CO (US)

(21) Appl. No.: 18/937,910

(22) Filed: Nov. 5, 2024

(51) Int. Cl. H04W 12/37; H04W 12/088; H04W 12/69

(52) U.S. Cl. CPC H04W 12/37; H04W 12/088; H04W 12/69

(57) ABSTRACT

Technologies for security service management of a cellular network are described. The cellular network includes a multi-service security slice including a set of security services. One method includes identifying a first user identifier associated with a first communication received from first user equipment associated with a first user. The method further includes determining, based on the first user identifier, a first subset of security services of the multi-service security slice authorized for use by the first user. The method further includes causing generation of a first user security policy to enable the first communication to access each security service of the first subset of security services of the multi-service security slice.

### BACKGROUND

Telecommunication networks, such as cellular networks, have various resources that produce data and metadata concerning operations of the cellular network. A customer, such an enterprise customer, of a cellular network does not have access to the data and metadata generated by the network resources of the cellular network. Status reports, including error codes, may be generated which are indicative of deficiencies in operations of the network.

One type of cellular network is a Fifth generation (5G) wireless network. In a 5G wireless network, a 5G Standalone Core Network (5G SA core) is responsible for managing and routing data traffic, providing various network resources and services, and supporting the core functionalities of a 5G network. The term “SA” stands for “Stand-Alone,” indicating that this core network operates independently of any existing 4G (LTE) infrastructure. 5G wireless networks have the promise to provide higher throughput, lower latency, and higher availability compared with previous global wireless standards.

The cellular network may include a number of network slices, where each network slice includes an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services.

A network slice may be configured to provide user equipment with access to one or more security-related services or applications. A user associated with user equipment subscribes to one or more security services to enable those services to be provisioned to the user. To provide access to the subscribed security services, a network slice is provided in the cellular network which includes a selected set of security services that are pre-configured and customized on a per-user basis. In such cellular networks, each user-specific network slice is built to include only the one or more security services which the user has purchased. To provide the appropriate security services to each individual user, the cellular network must maintain multiple user-specific security slices, with each security slice customized specifically for a particular user. Accordingly, building and managing multiple customized security slices results in a large expenditure of overhead and inefficient provisioning of security services.

### BRIEF DESCRIPTION OF THE SEVERAL VIEWS OF THE DRAWINGS

The present disclosure is illustrated by way of example, and not by way of limitation, in the figures of the accompanying drawings.

FIG. 1 is a block diagram of a cellular network system including a security slice manager to manage a multi-service security slice, according to some embodiments.

FIG. 2 is a block diagram depicting operations of a cellular network including a security slice manager, according to some embodiments.

FIG. 3 is a block diagram depicting an example including processing of a communication by a security slice manager managing a multi-service security slice of a cellular network, according to some embodiments.

FIG. 4 is a flow diagram of a method for managing a multi-service security slice, according to various embodiments.

FIG. 5 illustrates a block diagram illustrating an exemplary computer device, in accordance with implementations of the present disclosure.

### DETAILED DESCRIPTION

Technologies for managing a multi-service security slice to provide security services to users of a telecommunications network, such as a cellular network (e.g., 5G wireless network, 6G wireless network), are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Various user equipment (UE) associated with multiple different users communicate via a cellular network (i.e., user-initiated network traffic) to access one or more applications or systems. However, as described above, a customized network slice is built and managed for each user, where the user-specific network slice including one or more security services or applications which a particular user can access. Accordingly, there is a significant cost in terms of overhead usage and slice management that is incurred by configuring multiple user-specific network slices. Conventionally, there are no mechanisms to provision a collection of security services and dynamically orchestrate access to authorized security services in a cellular network on a per-user basis.

Aspects and embodiments of the present disclosure address the above and other deficiencies by providing a collection of security services or applications in single network slice (herein referred to as a “multi-service security slice”) to improve operations and efficiencies of a cellular network. According to embodiments, processing logic (herein referred to as a “security slice manager”) is provided to manage access to selected security services of the multi-service security slice by multiple different users. In an embodiment, the security slice manager dynamically determines which of the collection of security services of the multi-service security slice a user can access based on a user identifier (e.g., Data Network Name (DNN) identifier or a security slice identifier)). According to embodiments, the multi-service security slice can be provisioned as infrastructure as code, with interchangeable security functionality (e.g., multiple different security applications) embedded within the multi-service security slice.

In one or more embodiments, the security slice manager identifies a user-specific identifier (herein the “user identifier”) associated with a communication from user equipment (UE) relating to the user. The security slice manager uses the user identifier to identify the user and a user profile. The user profile can be used to generate a security policy which identifies a subset of one or more security applications which the user can access (e.g., a subset of security services of a multi-service security slice authorized for use by the user). In an embodiment, using the user profile and corresponding security policy, the security slice manager enables the subset of security applications of the multi-service security slice that are identified in the security policy. According to embodiments, the communication is routed through the enabled subset of security applications of the multi-service security slice. The management and orchestration of selected security services maintained in a single multi-service security slice based on a user identifier significantly reduces the cost and overhead associated with providing a user-specific security slice for each of the multiple different users. According to embodiments, the multi-service security slice represents a network traffic path for communications associated with user equipment with the set of multiple different security applications located within and along the traffic path. Advantageously, a selected subset of the security applications can be enabled for a particular user based on a corresponding security policy such that the user's traffic is routed through the selected subset of security applications.

Aspects and embodiments of the present disclosure can provide a cellular network including a single multi-service security slice including a set of security applications maintained and managed by a security slice manager, instead of maintaining a user-specific security slice for each of the potential users. According to embodiments, the security slice manager communicates with a firewall associated with the multi-service security slice. The firewall receives a communication (e.g., a set of packets) from user equipment associated with the user via a user plane function (UDF). The UDF is configured to perform packet processing including one or more of the routing and forwarding of the packets of the communication to the firewall of the multi-service security slice, quality of service handling, packet data unit (PDU) session management, and ultrareliable low-latency communication (URLLC) management.

According to embodiments, when a user communication “hits” the firewall of the multi-service security slice, the security slice manager determines the corresponding user identifier (i.e., a DNN ID or a slice identifier) and uses the user identifier to determine which subset of security services within the security slice the user communication is to have access to (i.e., the subset of authorized security services), in accordance with a security policy associated with the user identifier. According to embodiments, the firewall of the multi-service security slice extracts the user identifier from the incoming communication and provides the user identifier to the security manager.

According to embodiments, the security slice manager maintains the security policy for each user. The security slice manager maps the user identifier to the corresponding security policy for that user. The security slice manager uses the identified security policy information to determine the subset of authorized security services to which the user has access (i.e., the one or more security services of the multi-service security slice authorized for use by the particular user. The security slice manager determines the subset of authorized security services of the multi-service security slice that are enabled for the particular user based on the user identifier. Advantageously, customized subsets of security services can be generated for each user, without any network configuration modifications.

According to embodiments, the security slice manager can update the set of available security applications provided in the multi-service security slice. For example, the security slice manager can add a new or additional security service to the multi-service security slice, delete a security service from the multi-service security slice, or update a security service in the multi-service security slice. According to embodiments, the security slice manager can manage updates to a security policy associated with a user (e.g., add a security service to a security policy to enable access by the user to the security service, remove a security service from a security policy to disable access by the user to the security service, etc.).

According to embodiments, the security slice manager can enable a particular security service for access by multiple different users concurrently. In this embodiment, the multiple users can be logically separated as distinct “tenants” on that particular/shared security service so that the multiple users can access the same security service at the same time. In an embodiment, multiple tenants are created within the security service and the multiple tenants'access is logically separated. According to embodiments, one or more of the security services of the multi-service security slice can be multi-tenant, such that the security service can support multiple different tenants or users at the same time and maintain the respective tenant's data and traffic separate across the security service.

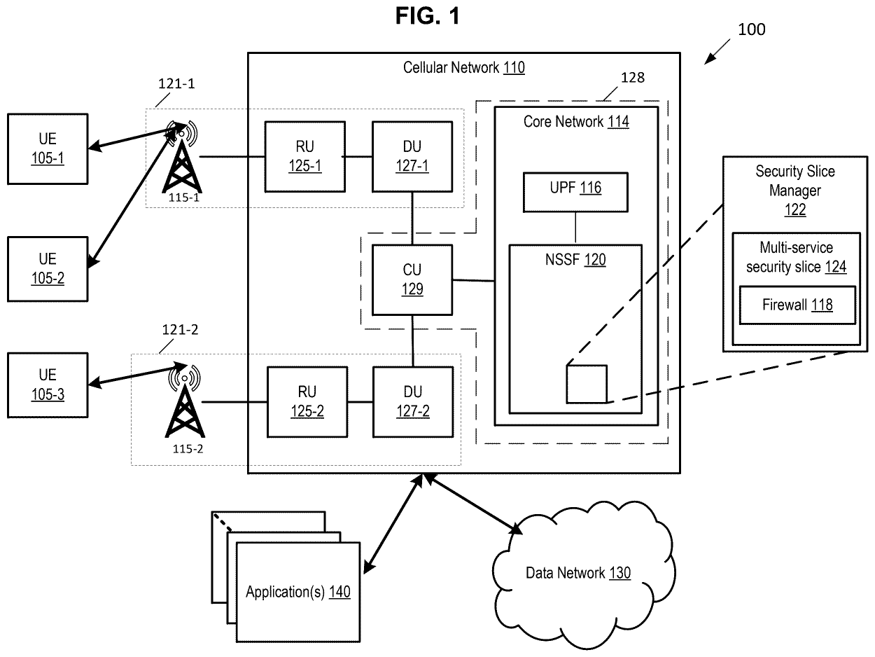

FIG. 1 is a block diagram of a cellular network system 100 (“system 100”) implementing a security slice manager 122 in an example cellular network 110 (e.g., a fifth generation (5G) network, a sixth generation (6G) network, a seventh generation (7G) network, etc.), according to embodiments of the present disclosure. FIG. 1 represents an embodiment of the cellular network 110 which can accommodate the cloud-based architecture. System 100 can include: user equipment (UE(s)) 105 (UE 105-1, UE 105-2, UE 105-3); base station structure 115; cellular network 120; radio units 125 (“RUs 125”); distributed units 127 (“DUs 127”); centralized unit 129 (“CU 129”); and a core network 114.

In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 105 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 110. As illustrated, two base stations are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations and many CUs 129. Structure 115 can include one or more antennas that allow RUs 125 to communicate wirelessly with UEs 105. RUs 125 can represent an edge of cellular network 120 where data is transitioned to wireless communication. The radio access technology (RAT) used by RU 125 may be 5G New Radio (NR), or some other RAT. The remainder of cellular network 110 may be based on an exclusive 5G architecture, a hybrid 4G/5G architecture, a 4G architecture, or some other cellular network architecture. Base station equipment 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum. One or more DUs, such as DU 127-1, may communicate with CU 129. Collectively, an RU, DU, and CU create a gNodeB, which serves as the radio access network (RAN) of cellular network 110. CU 129 can communicate with 5G core 139. The specific architecture of cellular network 120 can vary by embodiment. Edge cloud server systems outside of cellular network 110 may communicate, either directly, via the Internet, or via some other network, with components of cellular network 120. For example, DU 127-1 may be able to communicate with an edge cloud server system without routing data through CU 129 or core network 114. Other DUs may or may not have this capability.

While FIG. 1 illustrates various components of cellular network 110, other embodiments of cellular network 110 can vary the arrangement, communication paths, and specific components of cellular network 110. While RU 125 may include specialized radio access componentry to enable wireless communication with UE 105, other components of cellular network 110 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and core network 114. Functionality of such components can be co-located or located at disparate physical server systems. For example, certain components of core network 114 may be co-located with components of CU 129.

In a possible virtualized O-RAN implementation, CU 129 and core network 114 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129 and core network 114. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 110 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by an orchestrator. Orchestrator can represent various software processes executed by underlying computer hardware. Orchestrator can monitor cellular network 110 and determine the amount and location at which cellular network functions should be deployed to meet or attempt to meet service level agreements (SLAs) across slices of the cellular network.

Orchestrator can allow for the instantiation of new cloud-based components of cellular network 110. As an example, to instantiate a new core function, orchestrator can perform a pipeline of calling the core function code from a software repository incorporated as part of, or separate from, cellular network 110; pulling corresponding configuration files (e.g., helm charts); creating Kubernetes nodes/pods; loading the related core function containers; configuring the core function; and activating other support functions (e.g., Prometheus, instances/connections to test tools).

In an embodiment, the core network 114 can perform control plane (CP) functions. In at least one embodiment, an architecture in which software is composed of small independent services that communicate over well-defined APIs may be used for implementing some of the core network functions. For example, control plane (CP) network functions for performing session management may be implemented as containerized applications. A container-based implementation may offer improved scalability and availability over other approaches.

Components such as the DUs 127, CU 129, orchestrator, and 5G core may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and a network slice selection function (NSSF) 120. NRF can allow 5G network functions (NFs) to register and discover each other via a standards-based application programming interface (API). NSSF 120 can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating updating and removing protocol data unit (PDU) sessions, and managing session context with the user plane function (UPF).

The primary core network functions can include one or more user plane functions (UPF) 116. The UPF 116 may perform packet processing including routing and forwarding, quality of service (QoS) handling, and packet data unit (PDU) session management. The UPF 116 may serve as an ingress and egress point for user plane traffic and provide anchored mobility support for UE(s) 105. For example, the UPF 116 may provide an anchor point between the UE(s) 105 and the data network 130 and applications 140 as the UE 105 moves between coverage areas.

According to embodiments, the cellular network 110 connects user equipment (UE) 105 to the data network (DN) 130 and one or more applications 140 using the base station 115 and the core network 114. The data network 130 can include the Internet, a local area network (LAN), a wide area network (WAN), a private data network, a wireless network, a wired network, or a combination of networks. The UE 105 can include an electronic device with wireless connectivity or cellular communication capability, such as a mobile phone or handheld computing device. In at least one example, the UE 105 can include a 5G smartphone or a 5G cellular device that connects to the base station 115 via a wireless connection. The UE 105 can include one of a number of UEs 105 that are in communication with the cellular network 110 including mobile and non-mobile computing devices. For example, the UEs 105 may include laptop computers, desktop computers, an Internet-of-Things (IoT) devices, autonomous mobile robotic devices, fixed wireless access devices, cellular modems, cellular-enabled computerized devices, sensor devices, gaming devices, access points (APs), and/or any other electronic computing device that includes a wireless or wired communications interface to access the base station 115.

In an embodiment, the base station 115 is an open radio access network (ORAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

According to embodiments, traffic associated with the UE(s) 105 is routed by the UPF 116 to a firewall 118 of the multi-service security slice 124 of the core network 114. According to embodiments, for each transmission received from the UPF 116, the firewall 118 extracts a user identifier from the user communication. In an embodiment, each UE 105 is associated with a user, which is in turn associated with a unique user identifier. In an embodiment, the user identifier is a Data Network Name (DNN) identifier. In an embodiment, when a user is authenticated, the user identifier collected by the firewall 118 for that user (e.g., derived from a subscriber identity module (SIM) of the corresponding UE 105). According to embodiments, the user identifier used for access to security services of the multi-service security slice can be determined for any SIM type (e.g., any physical SIM or eSIM type may be used in connection with the multi-service security slice)

The firewall 118 is communicatively coupled to the NSSF 120 of the core network 114. The NSSF 120 is configured to select network slice instances of the core network 114. A network slice (or network slice instance) can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services.

A network slice functions as a virtual network operating on cellular network 110. Cellular network 110 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

In some cases, the cellular network 110 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

The core network 114 may include a set of network elements that are configured to offer various data and telecommunications services to subscribers or end users of user equipment, such as UE(s) 105. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The cellular network 110 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

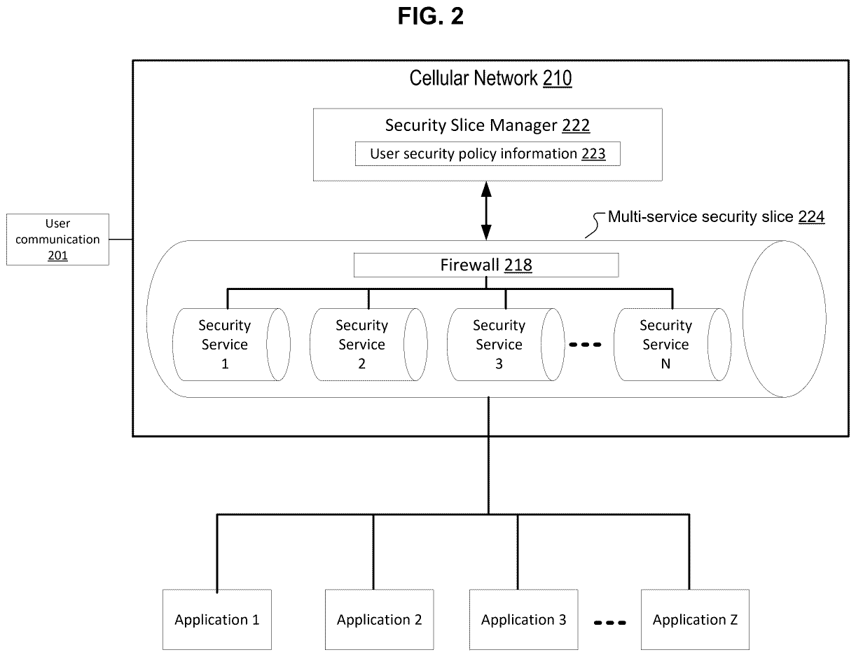

According to embodiments, the NSSF 120 includes a security slice manager 122. The security slice manager 122 is configured to manage functionality associated with a multi-service security slice 124. The multi-service slice includes a set of multiple different security services or security applications. Example security services included in the multi-service security slice 124 include, but are not limited to, a zero trust infrastructure/service, a network threat detection service, an IOT security device service, a web application firewall, a security monitoring and prevention solution service, a security data services, etc. Advantageously, the multi-service security slice 124 represents a traffic path with multiple different security services located therein. According to embodiments, the multi-service security slice 124 can be provided at an “edge” of the cellular network 110 (e.g., closer to end user devices and equipment) or via an aggregated data center. Operations of the security slice manager 122 and multi-service security slice 124 are described in greater detail below with reference to FIG. 2.

As shown in FIG. 2, the cellular network 210 includes the security slice manager 222 manages the security services (e.g., security service 1, security service 2, security service 3, . . . security service N, where N represents an integer) of the multi-service security slice 224. According to embodiments, the security slice manager 224 maintains a security policy associated with each user (user security policy information 223 of FIG. 2). Each user security policies identifies a subset of security services of the multi-service security slice 224 which a corresponding user is authorized to access. It is noted that the subset of security services accessible by a user may include any number of the security slices of the multi-service security slice 224 (e.g., one security service, all of the security services, etc.). In an embodiment, SMF may be utilized to share information with services located in the security slice. In an embodiment, a general packet radio service (GPRS) tunneling protocol (or GTP) to reach the UPF, and the GTP log data from SMF may be used to provide security and behavior analytic services. In another embodiment, the cellular network 210 may employ a radius server connecting GTP logs from UPF to one or more Radius-to-Security Services may be used.

In an embodiment, a user is authorized to access a security service if the user has a subscription to that particular security service. According to embodiments, the security slice manager 222 determines which subset of security services the user may access and routes a communication from that user to the identified subset of security services of the multi-service security slice 224.

According to embodiments, a firewall 218 of the multi-service security slice 224 receives a communication 201 associated with a user (i.e., a set of packets or network traffic to be processed via the cellular network 210) corresponding to a target application (e.g., application 1, application 2, application 3, . . . application Z, where Z represents an integer). In an embodiment, the firewall 218 determines a user identifier based on the user communication 201. In an embodiment, the user identifier is a DNN identifier that is determined based on the SIM information associated with the originating UE associated with the user relating to user communication 201. According to embodiments, the user identifier is provided by the firewall 218 to the security slice manager 222. The security slice manager 222 maps the user identifier associated with the user to the corresponding user security policy information 223 for that user. The security slice manager 222 uses the identified user security policy information 223 to determine the subset of authorized security services to which the user has access. The security slice manager 222 causes the firewall 218 to generate a security policy enabling access by the user to the identified subset of authorized security services within the multi-service security slice 224. In an embodiment, by enabling the selected subset of security services identified in accordance with the corresponding user security policy, the user communication 201 is caused to be routed to the identified subset of security services.

The user identifier is used by the security slice manager 222 to identify a user security policy associated with the respective user. The security slice manager 222 causes enforcement or implementation of the customized user security policy to route the user communication via the multi-service security slice 224 such that access is enabled to the identified subset of security services as the user communication is transmitted to the target application.

Advantageously, the single multi-service security slice may be maintained and managed by the security slice manager 222, instead of maintaining a user-specific security slice for each of the potential users. The single multi-service security slice can include a set of multiple different security services, and the security network manager can dynamically determine which subset of those security services a particular user can access, based on a user identifier associated with the particular user. This significantly reduces the cost and overhead associated with providing multiple security services to multiple different users.

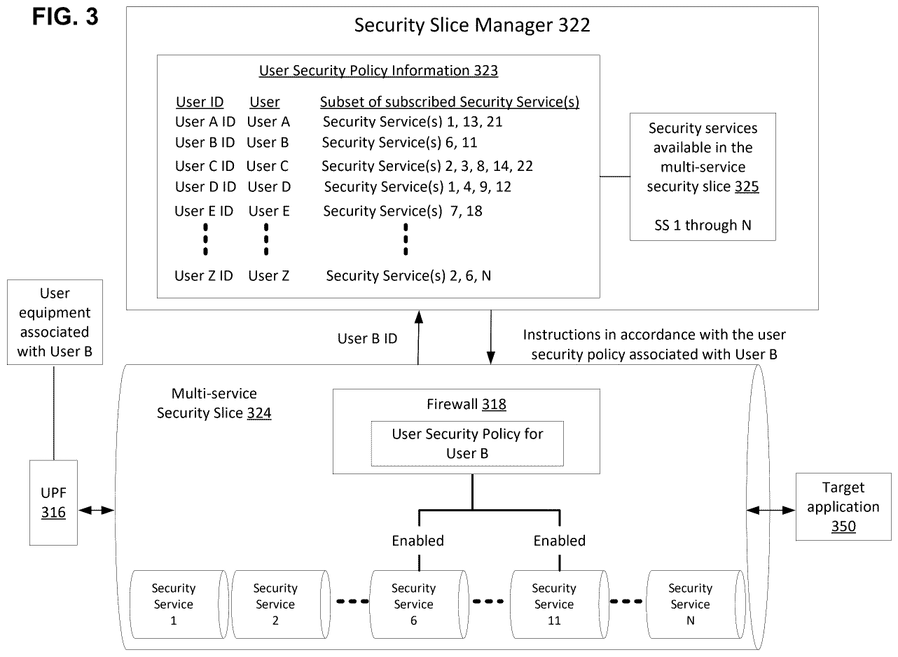

FIG. 3 illustrates an example security slice manager 322 managing the routing of a user communication originating from user equipment associated with an example user (e.g., User B) via a multi-service security slice 324. As shown in FIG. 3, the multi-service security slice 324 includes a set of security services (e.g., security-related applications), such as security service 1 through security service N (where N is an integer). Example security services included in the multi-service security slice 324 may include a zero trust infrastructure/service, a network threat detection service, a threat protection service, an IOT security device service, a web application firewall, a security monitoring and prevention solution service, a security data services, etc.

In the example shown in FIG. 3, a user communication is received by a firewall 318 of the multi-service security slice 324 from user equipment associated with User B. In the example shown in FIG. 3, the user communication originated by the user equipment associated with User B is intended for target application 350. According to embodiments, the user communication associated with User B is received by the firewall 318 from a UPF 316. In an embodiment, when the user equipment associated with User B (e.g., a smartphone, tablet, IOT device, autonomous mobile robot, a laptop) establishes a connection to a mobile network, the user equipment specifies the network to which access is desired. In an embodiment, the user communication includes a user identifier. For example, the user identifier may include a DNN identifier.

According to embodiments, the firewall 318 identifies the user identifier associated with User B (herein “User B ID”). In an embodiment, when the firewall 318 authenticates the user, the firewall 318 extracts or collects the User B ID and provides the User B ID to the security slice manager 322. As shown in FIG. 3, the security slice manager 322 maintains a list of security services 325 that are available in the multi-service security slice 324. In the example shown in FIG. 3, at the time of that the User B communication is processed, the set of security services available in the multi-service security slice 324 include security service 1 through security service N.

In an embodiment, the security slice manager 322 can dynamically manage the set of security services to add, delete, or update one or more security services. For example, the security slice manager 322 can add a new or additional security service (e.g., security service N+1) to the multi-service security slice 324. The security slice manager 322 can update the user security policy information for one or more users that are authorized to access the new or additional security service N+1. Advantageously, a new or additional security service can be added to the library of available security services managed by the security slice manager 322 and made available to users, without modifying the configuration of the network.

According to embodiments, the security slice manager 322 maintains user security policy information 323 associated with a set of users (e.g., User A, User B, User C, User D, User, E, . . . User Z). In an embodiment, the security slice manager 322 may maintain a data structure (e.g., a table) storing the user security policy information 323 for the set of users. As illustrated, the user security policy information 323 identifies a subset of one or more security services of the multi-service security slice 324 that a corresponding user can access. For example, if a first communication is identified as associated with User ID E, then the security slice manager 322 determines that the communication is associated with User E and authorizes access to a subset of security services including Security Service 7 and Security Service 18. If, in another example, a second communication is identified and associated with User ID C, then the security slice manager 322 determines that the communication is associated with User C and authorizes access to a subset of security services including Security Service 2, Security Service 3, Security Service 8, Security Service 14, and Security Service 22.

In the example shown in FIG. 3, based on the User B ID received identified by the firewall 318, the security slice manager 322 identifies the corresponding user security policy information from the stored library of user security policy information 323. The security slice manager 322 determines that the user security profile associated with User B indicates that user B is authorized to access Security Service 6 and Security Service 11. The security slice manager 322 sends instructions to the multi-service security slice 324 to cause the firewall 318 to generate a security policy for the current communication session associated with User B which indicates that Security Service 6 and Security Service 11 are enabled (i.e., while the remaining security services in the multi-service security slice 324 are disabled). In an embodiment, enabling the identified security services causes the User B communication to be routed to and access the identified security services (i.e., Security Service 6 and Security Service 11).

According to embodiments, the security slice manager 322 can provide the user security policy information to enable the firewall 318 to dynamically generate a security slice policy which indicates the subset of security services that the user has access to for a duration of the in-progress communication session.

In an embodiment, the security slice manager 322 can cause a particular security service to be enabled for multiple different users or tenants concurrently. In this embodiment, the multiple users can be logically separated on that shared security service so that the multiple users can access the same security service at the same time. In an embodiment, the multiple tenants are created within the security service and the respective multiple tenant's access is logically separated to enable concurrent access, while maintaining the respective tenant's data and traffic separate across the security service.

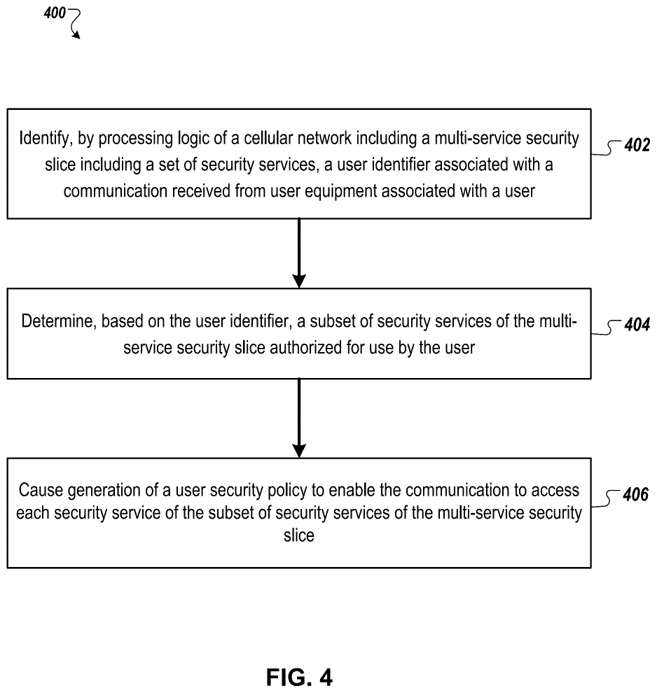

FIG. 4 is a flow diagram of a method 400 for managing a multi-service security slice of a cellular network according to some embodiments. The method 400 may be performed by processing logic of a cellular network that may comprise hardware (e.g., circuitry, dedicated logic, programmable logic, microcode, etc.), software (e.g., instructions run on a processing device to perform hardware simulation), or a combination thereof. In one embodiment, the method 400 is performed by the security slice manager 122, 222, 322 of FIGS. 1-3, respectively. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 402, processing logic of a cellular network including a multi-service security slice including a set of security services, a user identifier associated with a communication received from user equipment associated with a user. In an embodiment, the user identifier is a DNN identifier determined by a firewall of the multi-service security slice. In an embodiment, the firewall is network-aware and determines the user identifier (e.g., a DNN identifier) from the SIM of the user equipment.

At operation 404, the processing logic determines, based on the user identifier, a subset of security services of the multi-service security slice authorized for use by the user. In an embodiment, the processing logic maintains a data structure including user security policy information (e.g., user security policy information 223, 323 of FIGS. 2 and 3, respectively) that identifies a subset of security services of the multi-service security slice which the corresponding user is authorized to access.

At operation 406, the processing logic causes generation of a user security policy to enable the communication to access each security service of the subset of security services of the multi-service security slice. In an embodiment, the processing logic causes the firewall of the multi-service security slice to generate a user-specific security policy (e.g., a first user security policy for a first user, a second user security policy for a second user, and so on) to apply to the current communication session involving the user (e.g., the communication session including the transmission of communications between the user and a target application or network). In an embodiment, the user policy is applied to cause the subset of security services to be enabled within the multi-service security slice. According to embodiments, the communications of the current or active session access the identified subset of security services.

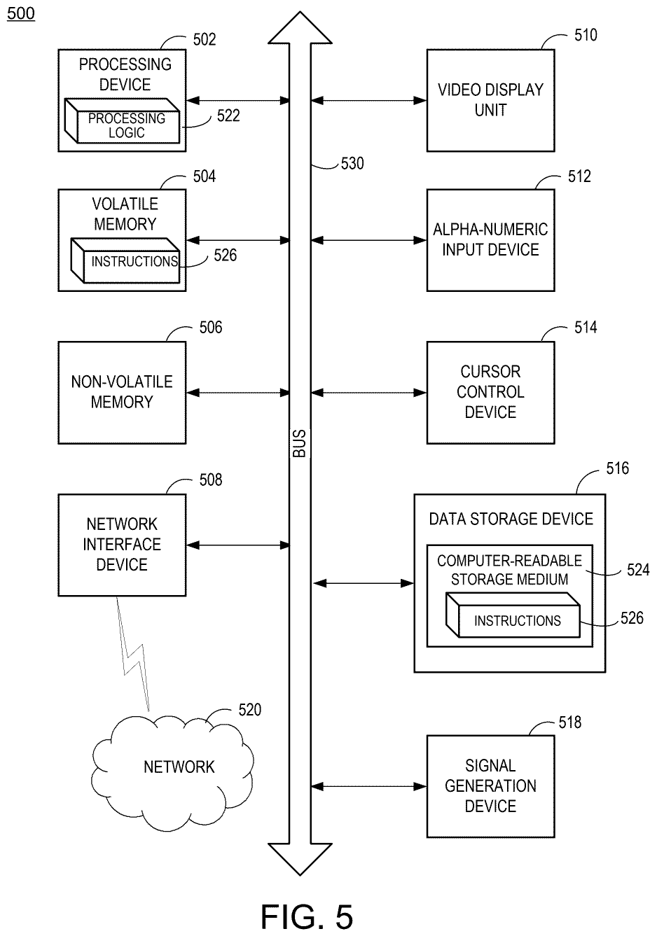

FIG. 5 illustrates a block diagram illustrating an exemplary computer device 500 (or computing device), in accordance with implementations of the present disclosure. Computer device 500 can correspond to the site design audit system 102 (or device), as described above. Example computer device 500 can be connected to other computer devices in a LAN, an intranet, an extranet, and/or the Internet. Computer device 500 can operate in the capacity of a server in a client-server network environment. Computer device 500 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 500 can include a processing device 502 (also referred to as a processor, CPU, or GPU), a volatile memory 504 (or main memory, e.g., read-only memory (ROM), flash memory, dynamic random access memory (DRAM) such as synchronous DRAM (SDRAM), etc.), a non-volatile memory 506 (e.g., flash memory, static random access memory (SRAM), etc.), and a secondary memory (e.g., a data storage device 516), which can communicate with each other via a bus 530.

Processing device 502 (which can include processing logic 522) represents one or more general-purpose processing devices such as a microprocessor, central processing unit, or the like. According to embodiments, the processing logic 522 may be the logic associated with security slice manager 122, 222, 323 of FIGS. 1, 2, and 3, respectively. More particularly, processing device 502 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 can also be one or more special-purpose processing devices such as an ASIC, a FPGA, a digital signal processor (DSP), network processor, or the like. In accordance with one or more aspects of the present disclosure, processing device 502 can be configured to execute instructions performing the method disclosed herein.

Example computer device 500 can further comprise a network interface device 508, which can be communicatively coupled to a network 520. Example computer device 500 can further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 518 (e.g., a speaker).

Data storage device 516 can include a computer-readable storage medium (or, more specifically, a non-transitory computer-readable storage medium) 524 on which is stored one or more sets of executable instructions 526. In accordance with one or more aspects of the present disclosure, executable instructions 526 can comprise executable instructions performing the method disclosed herein (e.g., instructions executable by security slice manager 122, 222, 323 of FIGS. 1, 2, and 3, respectively.

Executable instructions 526 can also reside, completely or at least partially, within volatile memory 504 and/or within processing device 502 during execution thereof by example computer device 500, volatile memory 504 and processing device 502 also constituting computer-readable storage media. Executable instructions 526 can further be transmitted or received over a network via network interface device 508.

While the computer-readable storage medium 524 is shown in FIG. 5 as a single medium, the term “computer-readable storage medium” or “non-transitory computer-readable storage medium storing instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A method comprising:
identifying, by a processing device of a cellular network comprising a multi-service security slice comprising a set of security services, a first user identifier associated with a first communication received from first user equipment associated with a first user;
determining, based on the first user identifier, a first subset of security services of the multi-service security slice authorized for use by the first user; and
causing generation of a first user security policy to enable the first communication to access each security service of the first subset of security services of the multi-service security slice.

2. The method of claim 1, further comprising providing information identifying the first subset of security services authorized for use by the first user to a firewall of the multi-service security slice, wherein the firewall generates the first user security policy based on the information.

3. The method of claim 1, wherein the first user identifier comprises a data network name identifier associated with the first user equipment.

4. The method of claim 1, further comprising:
identifying a second user identifier associated with a second communication received from second user equipment associated with a second user;
determining, based on the second user identifier, a second subset of security services of the multi-service security slice authorized for use by the second user; and
causing generation of a second user security policy to enable the second communication to access each security service of the second subset of security services of the multi-service security slice.

5. The method of claim 4, wherein the first subset of security services and the second subset of security services comprise a first security service.

6. The method of claim 5, wherein the first communication and the second communication access the first security service concurrently.

7. The method of claim 1, further comprising adding an additional security service to the set of security services of the multi-service security slice.

8. One or more non-transitory, computer-readable storage media having computer-readable instructions thereon which, when executed by one or more processing devices of a cellular network comprising a multi-service security slice comprising a set of security services, cause the one or more processing devices to perform operations comprising:
identifying a first user identifier associated with a first communication received from first user equipment associated with a first user;
determining, based on the first user identifier, a first subset of security services of the multi-service security slice authorized for use by the first user; and
causing generation of a first user security policy to enable the first communication to access each security service of the first subset of security services of the multi-service security slice.

9. The one or more non-transitory, computer-readable storage media of claim 8, the operations further comprising providing information identifying the first subset of security services authorized for use by the first user to a firewall of the multi-service security slice, wherein the firewall generates the first user security policy based on the information.

10. The one or more non-transitory, computer-readable storage media of claim 8, wherein the first user identifier comprises a data network name identifier associated with the first user equipment.

11. The one or more non-transitory, computer-readable storage media of claim 8, the operations further comprising:
identifying a second user identifier associated with a second communication received from second user equipment associated with a second user;
determining, based on the second user identifier, a second subset of security services of the multi-service security slice authorized for use by the second user; and
causing generation of a second user security policy to enable the second communication to access each security service of the second subset of security services of the multi-service security slice.

12. The one or more non-transitory, computer-readable storage media of claim 11, wherein the first subset of security services and the second subset of security services comprise a first security service.

13. The one or more non-transitory, computer-readable storage media of claim 12, wherein the first communication and the second communication access the first security service concurrently.

14. The one or more non-transitory, computer-readable storage media of claim 8, the operations further comprising adding an additional security service to the set of security services of the multi-service security slice.

15. A system comprising memory and a processing device coupled to the memory, wherein the processing device is configured to perform operations comprising:
identifying a first user identifier associated with a first communication received from first user equipment associated with a first user;
determining, based on the first user identifier, a first subset of security services of a multi-service security slice authorized for use by the first user; and
causing generation of a first user security policy to enable the first communication to access each security service of the first subset of security services of the multi-service security slice.

16. The system of claim 15, the operations further comprising providing information identifying the first subset of security services authorized for use by the first user to a firewall of the multi-service security slice, wherein the firewall generates the first user security policy based on the information.

17. The system of claim 15, wherein the first user identifier comprises a data network name identifier associated with the first user equipment.

18. The system of claim 15, the operations further comprising:
identifying a second user identifier associated with a second communication received from second user equipment associated with a second user;
determining, based on the second user identifier, a second subset of security services of the multi-service security slice authorized for use by the second user; and
causing generation of a second user security policy to enable the second communication to access each security service of the second subset of security services of the multi-service security slice.

19. The system of claim 18, wherein the first subset of security services and the second subset of security services comprise a first security service; and wherein the first communication and the second communication access the first security service concurrently.

20. The system of claim 15, the operations further comprising adding an additional security service to the multi-service security slice.
